(19) United States
(12) Patent Application Publication
(10) Pub. No.: US 2005/0020348 A1
(43) Pub. Date: Jan. 27, 2005

(54) Gaming machine with a translatable flat panel display

(76) Inventors: Alfred Thomas, Las Vegas, NV (US); Joel R. Jaffe, Evanston, IL (US); Benjamin T. Gomez, Chicago, IL (US)

Correspondence Address: JENKENS & GILCHRIST, P.C., 225 WEST WASHINGTON, SUITE 2600, CHICAGO, IL, 60606, US

(21) Appl. No.: 10/624,157

(22) Filed: Jul. 21, 2003

(51) Int. Cl. A63F 13/00

(52) U.S. Cl. 463/20

(57) ABSTRACT

A gaming machine with an improved game display is disclosed. A mobile flat panel display (FPD) is located in the game display to provide an additional attraction and entertainment to players. The FPD is connected to a drive mechanism that translates the FPD to various positions within the game display or moves the FPD out of the player's viewing area in the game display. The central processing unit controls the movement of the FPD and the video image displayed. If desired, the video image displayed may correlate with the position of the FPD in the game display as well as with the progression of the game.

### FIELD OF THE INVENTION

The present invention relates to gaming machines, and more particularly, to the use of flat panel displays capable of providing video content to a player while the display translates through the gaming machine's game display.

### BACKGROUND OF THE INVENTION

Gambling has become an increasingly important and popular form of entertainment. Gaming machines, such as reel slot machines, video poker machines, video keno machines, and video bingo machines are an importance source of income for the gaming industry. Consequently, the gaming industry continually searches for new types of games, or enhancements to existing games, that improve their entertainment value and attract players.

One method for enhancing the entertainment value of gaming machines is to give players more attractive game displays. Fanciful and visually appealing displays offer tremendous player appeal.

When first introduced, gaming machines had mechanical game displays that generally consisted of mechanical reels behind a glass viewing area. Later, these game displays began to utilize CRT technology. CRT technology allowed almost unlimited versatility in the game images that could be displayed. The game display is only limited by the gaming machine's capability to store video images in its memory. Furthermore, the video images can be animated, further enhancing the gaming experience.

Advancements in video display technology allowed the introduction of flat panel displays (FPD). Flat panel displays are smaller and produce less heat than the older CRT technology. Flat panel displays have replaced CRT's in some gaming machines, however, few other advancements using FPD's in gaming machines have been developed. What is needed is a more entertaining game display using flat panel displays to enhance the entertainment value of gaming machines.

### SUMMARY OF THE INVENTION

Flat panel displays are used in gaming machines to display the game and its outcome to players. In the past, gaming machines utilized fixed position game displays. Aside from the content shown on the display, the physical display itself was not part of the entertainment value of the game. The present invention makes the physical display itself part of the entertainment value of the gaming machine.

To enhance the entertainment value of the gaming machine, a flat panel display is translated around the gaming machine's game display, interacting with other game features. Flat panel displays (known in the art as FPD's) are such devices as LED displays, plasma displays, field emission displays, digital micromirror devices (DMD), and LCD displays.

The mobile FPD can be utilized as a game marker, as a pointer, or simply as a visual entertainment device that may or may not provide information pertinent to the game outcome. The mobile FPD may interact with mechanical, or other features of the game. While the FPD is being driven, it may display any variety of static or dynamic video images. These video images may be animations, motion pictures, photographs, or other video representations. The FPD may continuously or intermittently display a video image.

Furthermore, the video images may correlate to the FPD's location, game play (including game outcomes), and further may depend upon the combination of the FPD's location and game play. The combination of the mobile flat panel display and its displayed visual images gives the player greater visual interest and excitement during game play.

Many other potential applications for the mobile FPD exist that can provide enhanced gaming functions. Besides displaying visual images with entertainment value, the FPD can also provide players with game information. The player information may be conveyed by moving the FPD to the location in the game display to which the displayed information is pertinent.

Besides providing enhanced entertainment value, the mobile FPD can also provide potential economic advantages. In some cases, for example, a smaller FPD may be substituted for a much larger flat panel display. This capability may have significant cost advantages as the cost of some FPD's increases dramatically with their size. Alternatively, a single mobile FPD may be substituted for multiple static FPD's. The ability to substitute a single mobile FPD for multiple FPD's can also provide significant cost savings.

Several different embodiments of the present invention are discussed. All of them focus on the mobility of the display and the images displayed to provide enhanced entertainment value to the player.

### BRIEF DESCRIPTION OF THE DRAWINGS

FIG. 1 is a perspective view of an embodiment of a gaming machine.

FIG. 2 is a block diagram of the electronic components typically used in the gaming machine of FIG. 1.

FIG. 3 is an embodiment of a single dimension drive mechanism for a mobile FPD.

FIG. 4 is an embodiment of a two-dimensional drive mechanism for a mobile FPD.

FIG. 5 is a gaming machine illustrating a mobile FPD translatable in a single dimension.

FIG. 6 is the embodiment of FIG. 5 showing the mobile FPD at a first position in the game display and displaying a first image.

FIG. 7 is the embodiment shown in FIG. 5 with the FPD translated to a second position and displaying a second image.

FIG. 8 is a gaming machine illustrating a mobile FPD translatable in two dimensions.

FIG. 9 is the embodiment shown in FIG. 8 with the FPD at a first position and displaying a first image.

FIG. 10 is the embodiment shown in FIG. 8 with the FPD translated to a second position and displaying a second image.

FIG. 11 is a gaming machine illustrating a mobile FPD translatable in two dimensions with the drive mechanism located behind the game display.

FIG. 12 is the embodiment shown in FIG. 11 with the FPD translated to a first position displaying a first video image.

FIG. 13 is the embodiment shown in FIG. 11 with the FPD translated to a second position displaying a second video image.

FIG. 14 is a gaming machine illustrating a FPD translated in a rotational motion.

FIG. 15 is the embodiment shown in FIG. 14 with the FPD translated to a first position displaying a first video image.

FIG. 16 is the embodiment shown in FIG. 14 with the FPD translated to a second position displaying a second video image.

### DETAILED DESCRIPTION

The description of the preferred examples is to be construed as exemplary only and does not describe every possible embodiment of the invention. Many alternative embodiments could be implemented, using either current technology or technology developed after the filing date of this patent, which would still fall within the scope of the claims defining the invention.

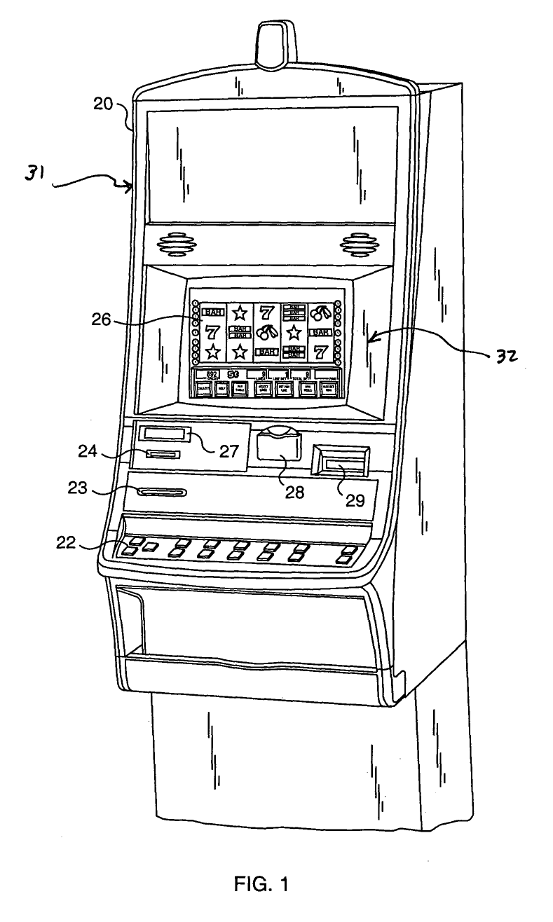

FIG. 1 shows a perspective view of a typical gaming machine 20 that may be used in conjunction with the present invention. The gaming machine may have varying structures and methods of operation. Gaming machine 20, for example, may be a mechanical gaming machine configured to play mechanical slots, or it may be an electromechanical or electronic gaming machine configured to play a video casino game such as blackjack, slots, keno, bingo, poker, etc.

Typical components found in a gaming machine 20 are described below. It should be understood that many other components and interfaces exist and could be used in any number of combinations to create a variety of gaming machines.

The game itself is displayed to the player on a game display 35, such as a video game display 26, or a mechanical display. The video game display 26 may be a cathode ray tube (CRT) or a flat panel display (FPD). The video game display 26 may include a touch screen overlaying the monitor to allow players to make game related selections, or any other selections associated with gaming.

In the alternative, instead of a video display, the gaming machine 20 may use a mechanical game display. One example of a mechanical game display is the traditional slot machine, which uses a number of mechanical reels to display the game and its outcome.

A wager acceptor to initiate play on the gaming machine may include a coin slot acceptor 28 or a note acceptor 29 to enter value to the gaming machine 20. A push button panel 22 is typically offered to allow players to make game selections. A touch screen may also be provided to provide players with an alternative method for making game selections.

Many gaming machines are also equipped with a player tracking card reader 24. A player may be enrolled in the gaming establishment's player club and may be awarded certain complimentary services/offers as that player collects points on his player tracking account. The player inserts his card into the reader, which allows the casinos computers to register that player's wagering activity at that gaming machine. The gaming machine 20 may also include a player tracking display 27 to be used with the player tracking card and player tracking card reader 24.

Many gaming establishments are implementing systems that are less dependent on cash. These systems often rely on ticket printers 23 installed in the gaming machine 20. These ticket printers may be used to print and/or read ticket vouchers, which are encoded with some monetary value. Typically, these systems utilize a barcode and barcode reader to read the ticket voucher, which may contain the casino name, ticket voucher validation number, etc.

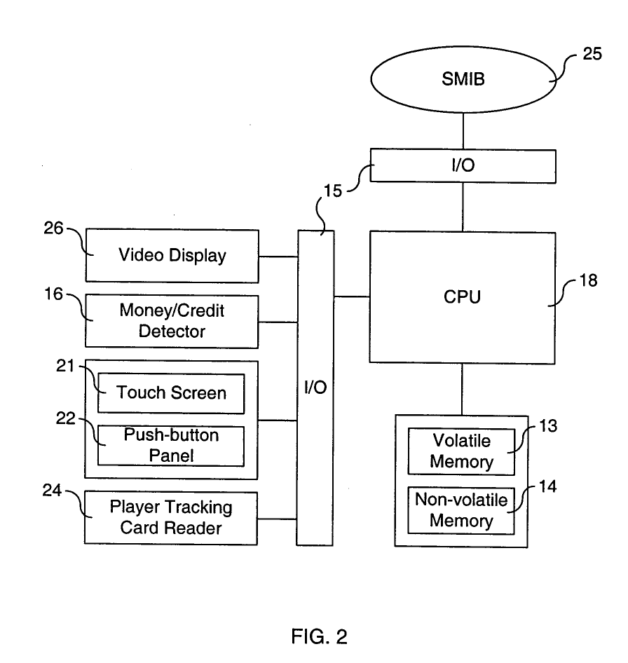

The various gaming machine peripheral devices described above are controlled by a central processing unit (CPU) 18 (such as a microprocessor or micro controller) as shown in FIG. 2. The peripheral devices shown in FIG. 2 include the push button panel 22, a player tracking card reader 24, a video display 26, and a touch screen 21. The number and type of peripheral devices vary depending upon the options and capabilities desired for any particular gaming machine.

Besides controlling each of the peripheral devices, the CPU 18 also controls the play of the game and the game outcome. The CPU 18 only determines a game outcome for some basic wagering games. In more sophisticated wagering games, the CPU 18 develops the game play through several intermediate game outcomes and then determines a final game outcome. Game outcome will be used to refer to either a final game outcome (which determines the outcome of the wager) or to an intermediate game outcome (which may or may not determine a wager outcome).

The CPU 18 controls these peripheral devices and the game play with a volatile memory 13 (e.g., a random-access memory (RAM)), a non-volatile memory (or static memory) 14 (such as an EEPROM), and an input/output (I/O) circuit 15. It should be appreciated that although only one microprocessor is shown, the CPU 18 may include multiple microprocessors and other ancillary electronic components. These components may include video controllers, video RAM, and other miscellaneous controllers and processors. Similarly, the memory of the CPU 18 may include multiple RAM and multiple program memories. Although the I/O circuit may be shown as a single block, the I/O circuit may also include many different types of I/O circuits.

Besides the base game 32, the gaming machine 20 shown in FIG. 1 may also include a bonus game that is typically included in a top box 31. The top box is a cabinet containing the bonus game and is generally attached to the top of the base game 32. The top box has an opening to define a game display 35. Both the base and the bonus games may have mechanical, electromechanical, or electronic game displays. The electromechanical top box is generally covered with glass to protect the bonus game. It is in these top boxes that the present invention can be most readily adapted to function.

In accordance with the present invention, a flat panel display (FPD) 33 is driven by a drive mechanism over or around the game display 35. The small size, weight, and electrical requirements of the FPD 33 facilitates its movement in the game display 35. Although the ample space in the top box can easily accommodate the mobile FPD 33 and its associated drive mechanism, the mobile FPD is also adaptable to a traditional static FPD or CRT display. In this embodiment, the mobile FPD 33 overlaps the traditional static CRT or FPD. Consequently, the mobile FPD 33 can be utilized in conjunction with any type of game display (e.g., CRT, static flat panel display, electromechanical, mechanical, or in any combination of electronic, mechanical, or electromechanical game display hardware).

The CPU 18 is used to control the translational movement of the FPD 33 within the game display 35 and the visual image displayed on the FPD. As the CPU 18 presents the game, it can also control the drive mechanism and the video image displayed on the FPD 33. This allows the CPU 18 to coordinate the game play and any intermediate or final game outcome with both the FPD 33 position as well as the video image displayed on the FPD. The FPD 33 may be a liquid crystal display (LCD), a LED display, a plasma display, field emission display, a digital micromirror device (DMD), or any other type of technology that can produce a video image on a generally flat surface. The display may even use relatively flexible organic LED's (OLED's). The display may be framed and may exist in any shape consistent with the technology utilized with a flat panel display. For example, an LCD may be cut into shapes such as circles, triangles, or any free-form shape desired.

The FPD 33 may be driven by any number of different drive mechanisms (either open or closed loop) for translating the FPD. These drive mechanisms may include, but are not limited to, ballscrew and jacknut devices, belt and pulley devices, electromagnetic linear drive mechanisms, cam and follower devices, and gear drives. The drivers for these systems may include stepper motors, server motors, and gear motors (with and without mechanical and electromechanical encoders and other feedback technologies).

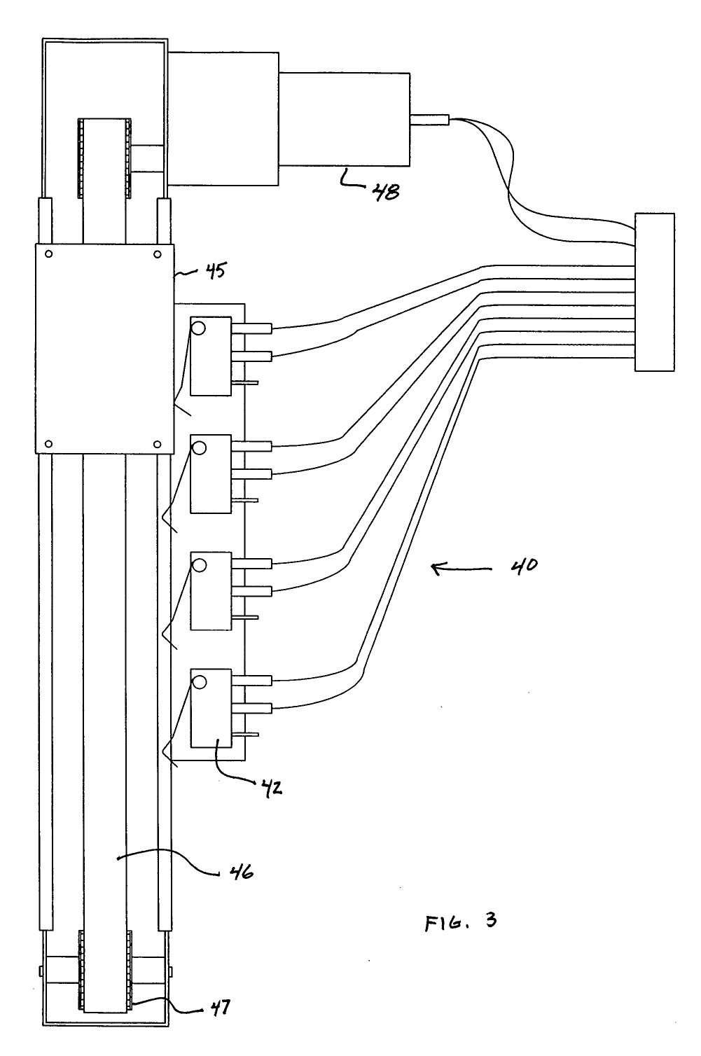

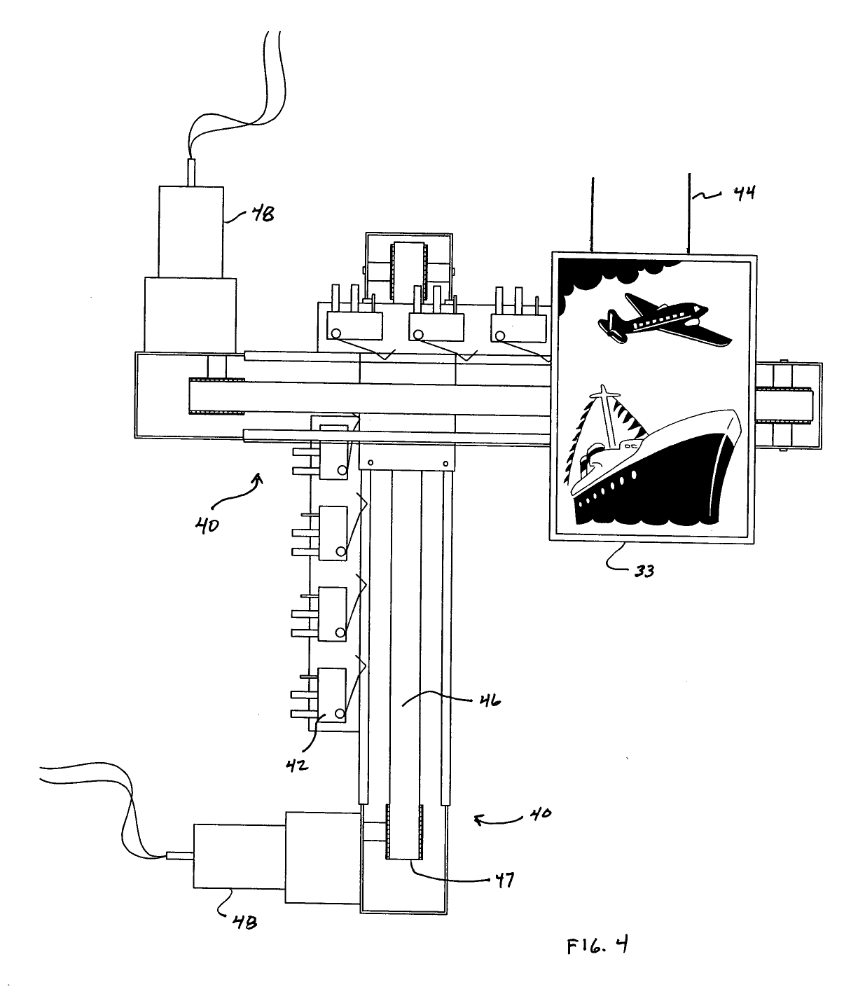

In one embodiment, as shown in FIG. 3, the FPD 33 (shown in FIG. 4) is connected to a conveyor belt 46 driven by an electric motor, such as a stepper motor 48. The conveyor belt 46 is stretched between two sprockets 47. A metallic frame is typically used to position and hold the sprockets. The flat panel display 33 may be connected to the conveyor belts with a carriage 45. The carriage 45 may include a roller cam to fit in and follow the track in the game display 35. A stepper motor 48 drives one of the sprockets to move the conveyor belt with the attached FPD 33.

If desired, position sensing devices such as microswitches 42 may be positioned along the length of the frame to position the FPD 33. The microswitches trip in response to the carriage's 45 displacement of the microswitch. The microswitch completes a circuit indicating the position of the FPD 33 to the CPU 18. In response to the position signal, the CPU 18 may disconnect power to the stepper motor, stopping the conveyor belt and the FPD 33 in their current position. Alternatively, the position signal may be utilized by the CPU 18 to trigger a display on a video image on the FPD 33. The stopping position of the FPD 33 can be closely controlled depending upon the number of position sensing devices utilized and their position resolution capability. Power cables 49 are provided to the electric stepper motors, which are controlled by the CPU 18. A flat ribbon connector 44 (shown in FIG. 4) may connect the CPU 18 with the FPD 33 to provide electrical power and data communication.

Although the above drive system provides linear motion to the FPD 33, it may be desired to translate the FPD in two dimensions. If an additional degree of freedom is needed, a second conveyor assembly may be attached to the first conveyor assembly's carriage as shown in FIG. 4. The FPD 33 is then attached to the carriage 45 of the second conveyor assembly. Similar to the first conveyor assembly, the second conveyor assembly contains the same components described in the first conveyor assembly including microswitches and a stepper motor. By using the two carriages in combination, the FPD 33 may be positioned two-dimensionally anywhere on, or behind, the game display 35.

Although the description above has been directed toward the connection of the drive mechanism with the FPD 33 through a mechanical linkage (i.e., carriage 45), alternate methods of controlling the movement of the FPD may be utilized. For example, instead of a mechanical linkage from the gaming machine to the FPD 33, the FPD may be magnetically coupled (using either a permanent magnet or an electromagnet) to the drive mechanism through the game display 35. In one embodiment, the FPD 33 and the drive mechanism 40 may have a fixed magnet that can be used to develop a magnetic couple between the display and the drive mechanism. Movement of the drive mechanism is translated to the FPD 33 through the magnetic couple. The FPD 33 may slide over the display surface of the gaming machine or it may be assisted with rollers to reduce friction forces between the display and FPD. The FPD 33 may be self-powered using a battery. Video images may be transmitted using wireless technology from the CPU 18 to the FPD 33.

Several different methodologies can be implemented to control the video image displayed on the FPD 33. Two of these methodologies are described below, however, any other number of potential methodologies and technologies can be utilized. In addition, other methods exist for storing and controlling video images including proprietary and public protocols for transferring video image data.

The visual image displayed on the FPD 33 can be created using video data residing in the FPD onboard memory. For example, the CPU 18 selects a signal associated with a specific video image that is to be displayed on the FPD 33. The selected command signal is transmitted to the FPD 33 over a serial interface typically using a two-wire serial bus. The FPD processor matches the signal received from the CPU 18 to a specific video image (from a plurality of video images) stored in the FPD onboard memory. The FPD processor receives the signal and moves graphical information about the video image selected from the FPD onboard memory to the FPD video memory (or any other type of compatible memory). The FPD video controller, embedded in the FPD electronics, then displays the video image on the FPD 33.

The central processing unit controls the displayed image and the movement of the mobile FPD 33 to insure correlation with the top box bonus display game play. Any number of potential video images may be contained in memory on the FPD 33, including animations and motion pictures.

Alternatively, in another embodiment, the image on the FPD 33 may be driven directly from the CPU 18. When a video image is needed, the gaming machine's CPU 18 moves graphical information from its mass storage media to RAM video memory. The CPU 18 is coupled to a slave processing system for controlling the display of the video content on the mobile FPD 33. This processing system includes RAM storage for the temporary storage of video data and a mass storage device for storing video data (or any other type of compatible memory). A system controller may be utilized in conjunction with the RAM and mass video storage to access the mass storage device and transfer the data to the RAM storage devices. A video controller, embedded in the CPU 18, electronics reads the video memory and creates a video signal, which is then transmitted to the FPD 33 through a VGA ribbon cable 44. This cable is flat and can flex freely to allow the FPD 33 to move without damaging the cable or its associated connectors. This method drives the image on the FPD 33 directly, essentially transferring a video data stream from the CPU 18 to produce pixels for display on the FPD.

The video image display FPD 33 may take on many different forms. The video image may be static and display a single image. Alternatively, the video image may change and alternate static video images with time, position of the FPD 33, or with the game play. Furthermore, the video image may be dynamic and present to the player as an animated picture, motion picture, or moving picture. These video images, whether static or dynamic, may be presented to the player whether the FPD 33 is moving or stopped.

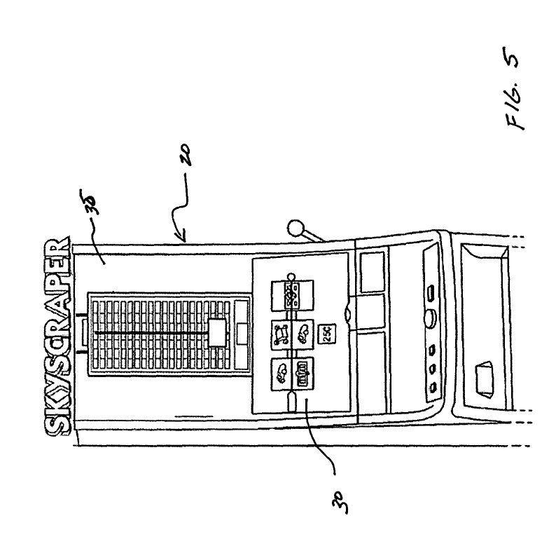

To more clearly describe the operation of the mobile flat panel display 33, several embodiments are described below in conjunction with a gaming machine. The drive mechanism utilized in this figure can be seen in FIG. 3. In FIG. 5, the drive mechanism 40 is substantially hidden from view behind the game display. The carriage connecting the FPD 33 to the conveyor belt moves the FPD along a predetermined track 34 contained in the game display 35. The track 34 extends from the front to the back of the game display to allow the drive mechanism to be hidden from view.

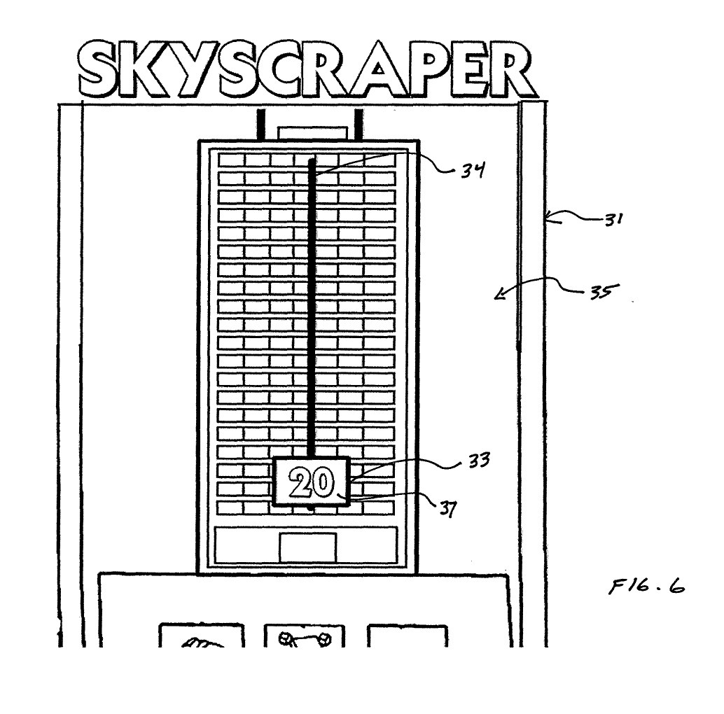

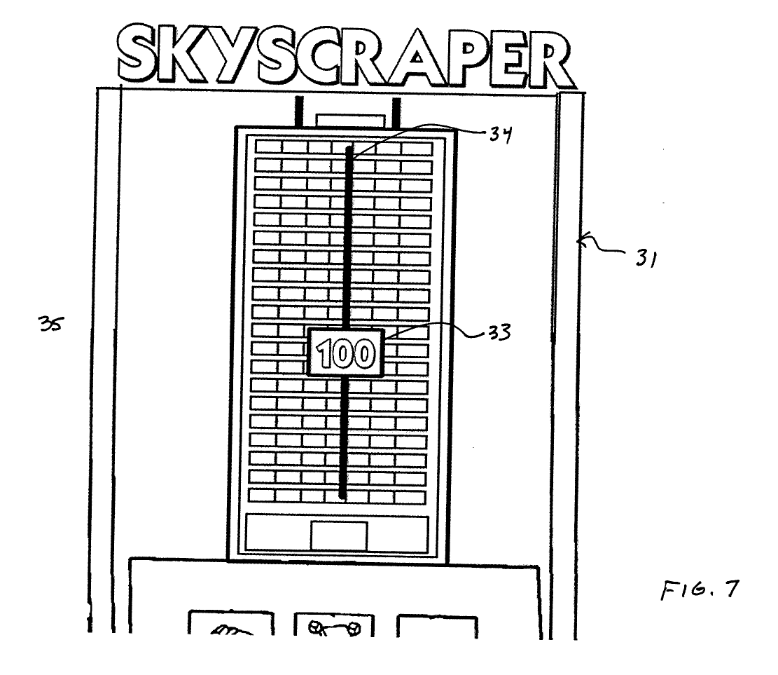

The top box of the game machine in FIG. 5 is shown in detail in FIG. 6. The FPD 33 displays a video image with a bonus value. As can be seen in FIG. 7, the FPD 33 has been translated upward along the track in the top box. The video image displayed on the FPD 33 has changed with the translation of the FPD. These drawings demonstrate how the video image displayed on the FPD 33 can be coordinated with the FPD's position. The video image displayed on the FPD 33 may also be correlated with the intermediate and/or final game outcomes, as well as with the overall game play. For example, the movement of the FPD 33 could be the result of a base game outcome that advanced the player in the bonus game to the new position associated with a larger bonus value (i.e., 100 versus only 20 credits).

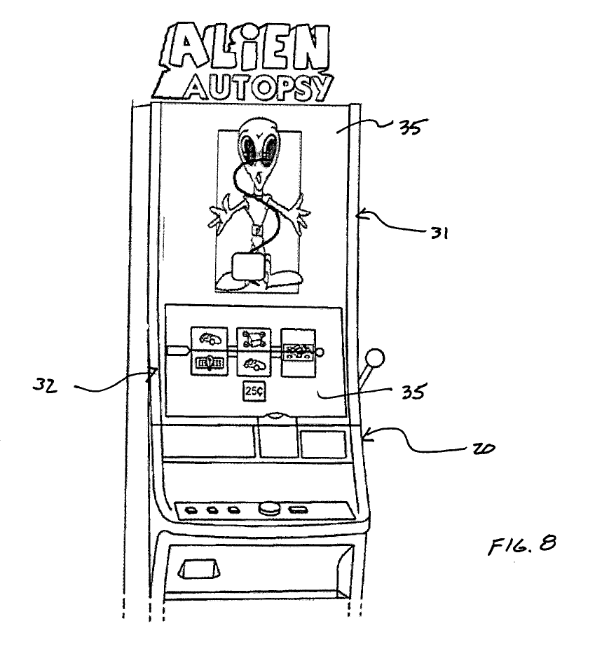

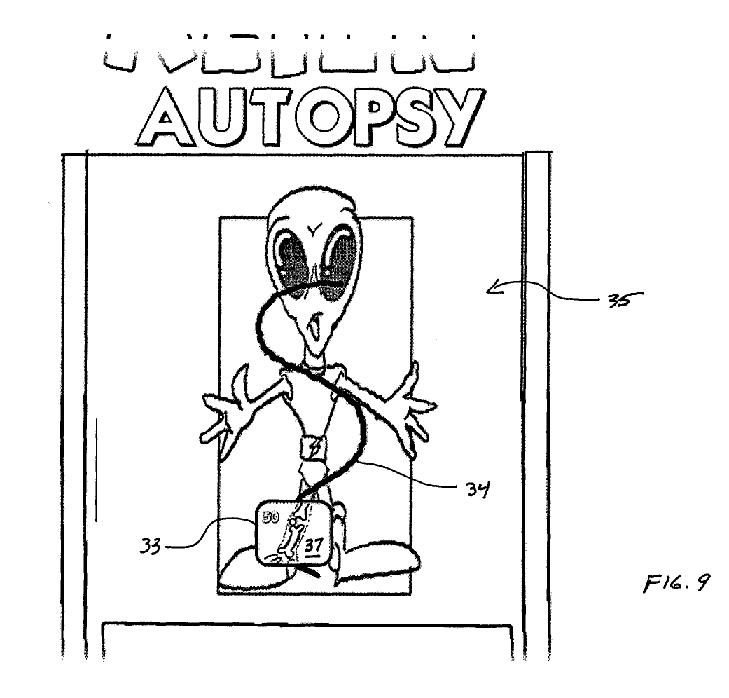

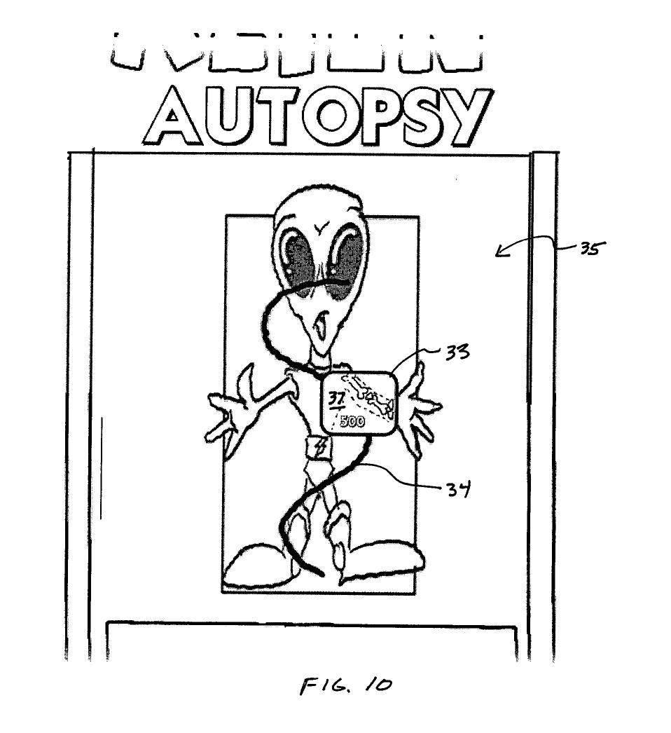

A somewhat more sophisticated mechanical drive mechanism drives the top box bonus game as illustrated in FIG. 8. In this embodiment, a mechanical drive mechanism translates the FPD 33 in both the vertical and horizontal directions, allowing the FPD to follow the curved track. The actual drive mechanism to accomplish this motion is shown in FIG. 4. The displayed video images may change as shown in FIG. 9 and FIG. 10.

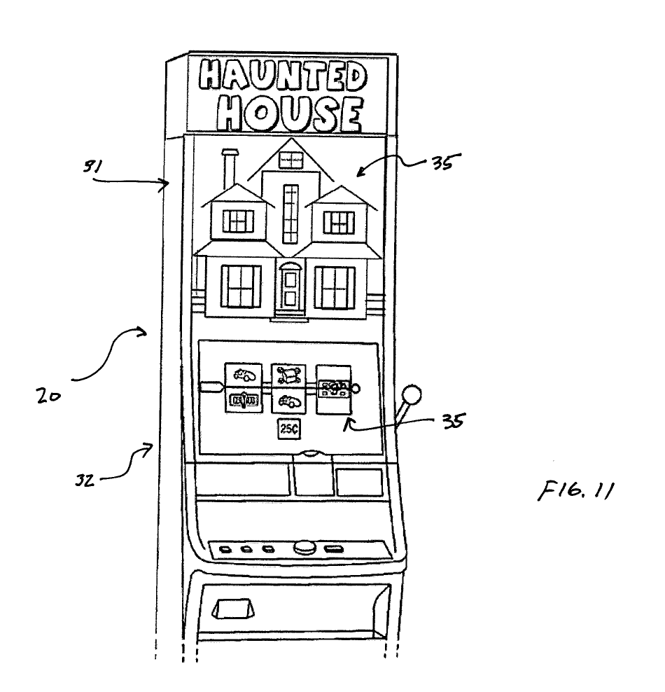

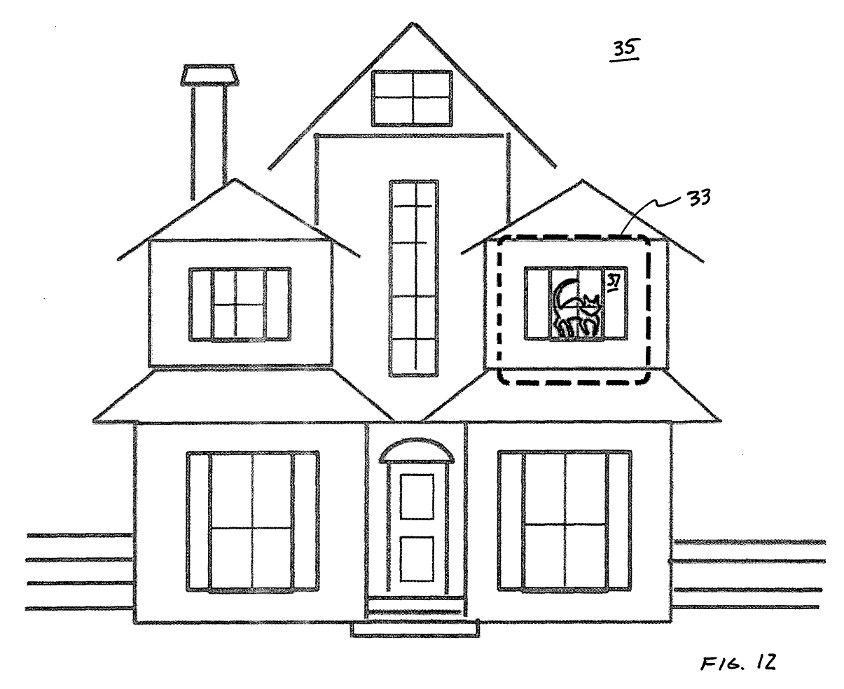

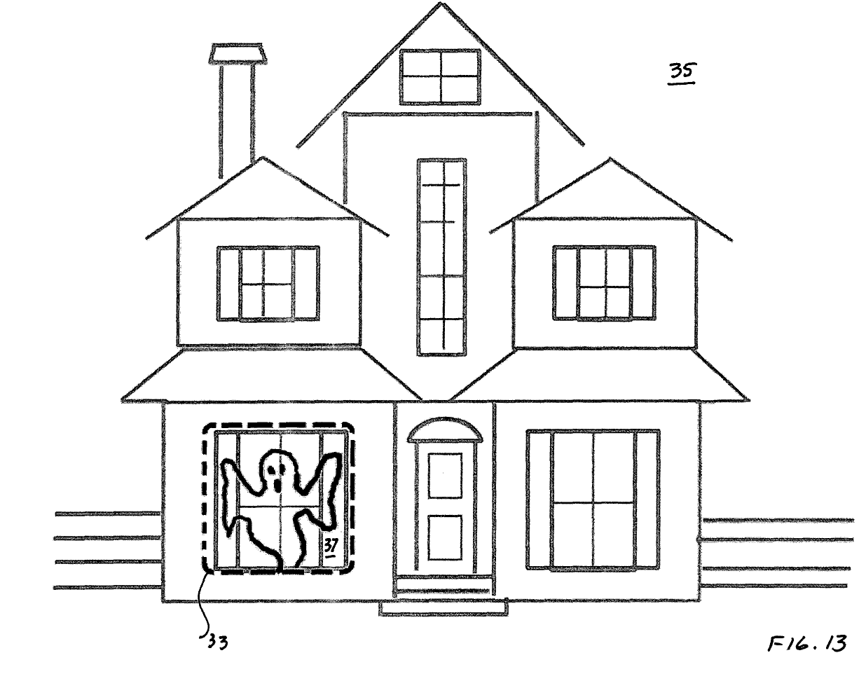

Yet another embodiment of the present invention uses a single FPD 33 translated behind the game display 35 as shown in FIG. 11. The game display 35 has openings (or apertures) with which the FPD 33 aligns to allow the video image to be seen in the game display by the player. As shown in FIG. 12, the FPD 33 can be seen through one of the openings in the game display 35. FIG. 13 shows the mobile FPD 33 translated to the next opening in the game display 35. As the FPD 33 is translated from one position in the next, the video images displayed on the FPD may change. The drive mechanism for this embodiment may be the same as shown in FIG. 4. Because the drive mechanism is entirely behind the game display, a track is not necessary. The game display 35 only requires apertures through which the FPD 33 may display its video image.

One advantage of the above described embodiment is that a much smaller mobile FPD 33 may be used in place of a much larger static CRT or FPD. Although multiple smaller static FPD's could be utilized behind each aperture, the use of a single FPD 33 eliminates the cost of multiple FPD's.

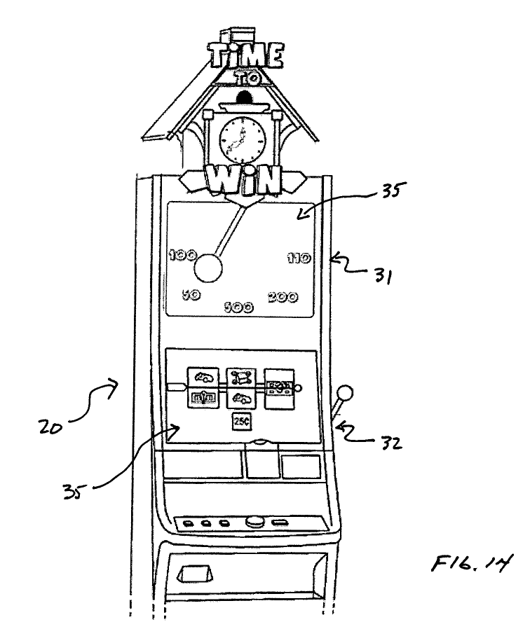

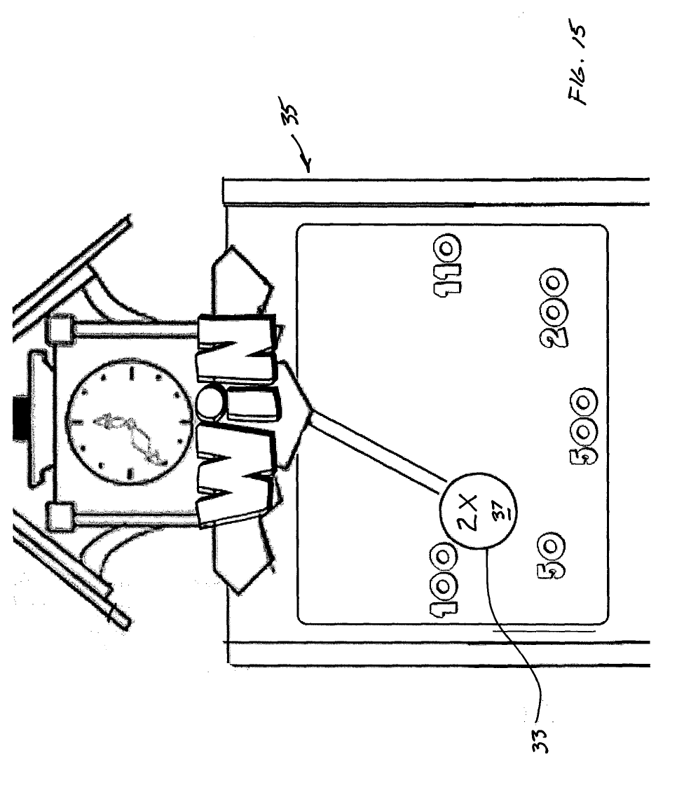

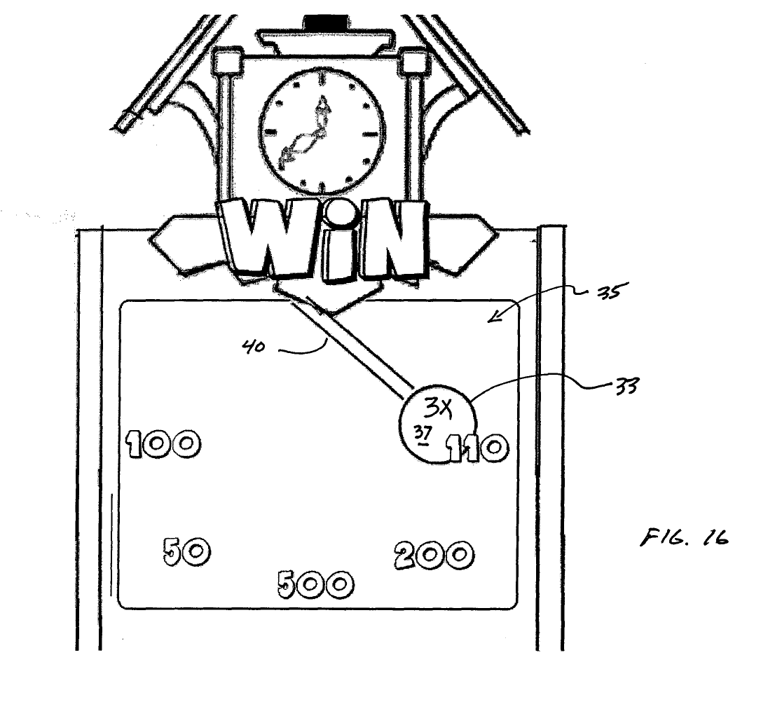

Another embodiment of the present invention is shown in FIG. 14. In this embodiment, the mobile FPD 33 is revolved around a fixed point. This circular motion can be achieved using the same type of stepper motor commonly used to drive mechanical slot reels. The stepper motor may rotate in a single direction to make complete circular revolutions and stop the pendulum at any point. Alternatively, the stepper motor may cause the FPD 33 to reverse rotational direction to create a pendulum motion. The video image displayed on the mobile FPD 33 in FIG. 15 and FIG. 16 may change while the mobile FPD is moving or after it has stopped. The pendulum, for example, may be stopped and point at a credit value as displayed in the FIG. 16. The pendulum FPD 33 may then light up and give the player a multiplier to be applied to the credit value determined by the pendulum's pointer.

Although the above embodiments generally discuss hiding the drive mechanism behind the game display, it is not necessary for the purposes of this invention. The drive mechanism may be displayed to the player and either themed into the game itself, or camouflaged to the extent possible to minimize its visual intrusion. For example, as shown in FIG. 14, the FPD 33 is shown swinging like a clock pendulum. For another example, the mobile FPD 33 in FIG. 8 might be driven by a visible drive mechanism replicating an x-ray machine.

In addition to hiding the FPD 33 drive mechanism, it may be desirable at times to hide the FPD itself. For most purposes, the FPD 33 translates within the game display viewing area in plain view of the player. In certain cases, however, it may be desirable to have the FPD 33 out of the player's line of sight until the FPD feature is desired.

Although all the embodiments discussed above describe the use of the mobile FPD in a top box bonus game, the mechanisms and apparatus could equally apply to the use of a mobile FPD 33 over a standard CRT or even standard static flat panel display. Also, although only a single FPD is discussed, multiple FPD's could be driven by a single drive mechanism, or independently driven. Furthermore, while the present invention has been described with reference to one or more particular embodiments, those skilled in the art will recognize that many changes may be made thereto without departing from the spirit and scope of the present invention. Each of these embodiments and obvious variations thereof is construed as falling within the spirit and scope of the claimed invention, which is set forth in the following claims.

1. A gaming machine having an improved game display comprising:
a flat panel display located in the game display;
a central processing unit having a memory for storing a plurality of video images, the central processing unit further for selecting one of the plurality of video images and communicating the selected video image to the flat panel display for display of the selected video image;
a drive mechanism connected to the flat panel display; and
the central processing unit further for controlling the drive mechanism to position the flat panel display.

2. The gaming machine as described in claim 1, wherein the central processing unit selects one of the plurality of video images to display on the flat panel display as a function of the position of the flat panel display in the game display.

3. The gaming machine as described in claim 1, wherein the central processing unit determines a game outcome, the game outcome determining the video image selected by the central processing unit.

4. The gaming machine as described in claim 1, wherein the central processing unit determines a game outcome, the game outcome determining the position of the flat panel display, the game outcome further for determining the video image displayed on the flat panel display.

5. The gaming machine described in claim 1, wherein the video image communicated to the flat panel display is a video data steam for producing an animated video image on the flat panel display.

6. The gaming machine as described in claim 1, wherein the drive mechanism comprises a carriage moveable relative to the gaming display, the flat panel display attached to the carriage, and a motor to drive the carriage and position the flat panel display.

7. The gaming machine described in claim 1, wherein the drive mechanism comprises a first carriage and a second carriage, the first carriage moveable relative to the game display, the second carriage moveable relative to the first carriage, the flat panel display connected to the second carriage, each carriage having a motor for positioning the flat panel display.

8. The gaming machine as described in claim 7, wherein the second carriage is magnetically coupled to the flat panel display through the game display.

9. The gaming machine as described in claim 1, wherein the game display has a track therethrough, the drive mechanism is located behind the game display, the flat panel display is located in front of the game display, and a carriage connects the drive mechanism to the flat panel display through the track.

10. A gaming machine having an improved game display comprising:
a flat panel display located in the game display, the flat panel display having a memory for storing a plurality of video images, each video image associated with one of a plurality of signals;
a central processing unit for selecting one of the plurality of signals and communicating the selected signal to the flat panel display;
the flat panel display for receiving the selected signal and identifying the video image associated with the selected signal for display of the associated video image;
a drive mechanism connected to the flat panel display; and
the central processing unit further for controlling the drive mechanism to position the flat panel display.

11. A method for providing an improved game display for a gaming machine comprising:
moving a flat panel display in the game display with a drive mechanism controlled by a central processing unit;
storing a plurality of video images;
selecting one of the plurality of video images with the central processing unit; and
displaying the selected video image on the flat panel display.

12. The method for providing an improved game display as described in claim 11, wherein the video image displayed is a function of the position of the flat panel display in the game display.

13. The method for providing an improved game display as described in claim 11, wherein the central processing unit determines a game outcome, the game outcome determining the video image selected.

14. The method for providing an improved game display as described in claim 11, wherein the central processing unit determines a game outcome, the game outcome determining the position of the flat panel display, the game outcome further determining the video image selected for display.

15. The method for providing an improved game display as described in claim 11, further comprising streaming video data from the central processing unit to the flat panel display to produce the video image.

16. The method for providing an improved game display as described in claim 11, further comprising:
storing the plurality of video images in a memory on the flat panel display, each of the plurality of video images associated with one of a plurality of signals;
selecting with the central processing unit one of the plurality of signals;
transmitting the selected signal to the flat panel display;
identifying the video image associated with the selected signal; and
displaying on the flat panel display the identified video image.
